(19) United States
(12) Patent Application Publication
(10) Pub. No.: US 2010/0270774 A1
(43) Pub. Date: Oct. 28, 2010

(54) Rotatable Trailer Hitch

(75) Inventors: William Boberg, Monroe, MI (US); Daniel Dague, Newport, MI (US)

Correspondence Address: BARNES & THORNBURG LLP, 600 ONE SUMMIT SQUARE, FORT WAYNE, IN, 46802, US

(73) Assignee: MIDWAY PRODUCTS GROUP, INC., Monroe, IN (US)

(21) Appl. No.: 12/769,076

(22) Filed: Apr. 28, 2010

Related U.S. Application Data
(60) Provisional application No. 61/173,250, filed on Apr. 28, 2009.

(51) Int. Cl. B60D 1/40

(52) U.S. Cl. 280/479.3

(57) ABSTRACT

A hitch assembly that allows a hitch portion to be rotated between extended and retracted positions. The hitch portion may be selectively fixed in either the extended or retracted position using a lock. A release may be provided to actuate the lock. Typically, the release includes a cam that acts on a surface of a shaft to actuate the lock.

### RELATED APPLICATION

The present application is related to and claims the benefit of U.S. Provisional Patent Application Ser. No. 61/173,250 filed on Apr. 28, 2009, entitled “Rotatable Trailer Hitch.” The entire disclosure of that application is hereby incorporated by reference.

### TECHNICAL FIELD

The present invention generally relates to a hitch for connecting trailers, hitch-mounted bike racks, and other hitch-mounted accessories. In particular, the invention relates to a hitch that pivots between extended and retracted positions.

### BACKGROUND

Trailer hitches are well known devices that are used to tow trailers, hitch-mounted bike racks, and other hitch-mounted accessories. Many hitches have a fixed position that extends from below a vehicle's bumper. Other hitches have been devised that may be rotated to a retracted position hidden beneath the bumper when not in use. However, the mechanisms that been devised for allowing rotation and locking of the hitch in various positions are overly complex and expensive to manufacture.

According, there is a need for a novel hitch assembly that allows rotation and locking of a hitch in extended and retracted positions with a relatively simple locking mechanism.

### SUMMARY

One embodiment of the present invention includes a hitch assembly with a hitch portion having an opening for receiving a hitch-mounted accessory in which the hitch position is rotatable between an extended position and a retracted position. A lock may be provided with a first locking plate with at least one prong and a second locking plate with at least one slot configured to receive the prong on the first locking plate. The lock may be configured to selectively fix the hitch portion in either the extended position or the retracted position when the prong is received in the slot. The hitch assembly may include a release assembly with a shaft, a rotatable cam that acts on a surface of the shaft, and a biasing member. In some cases, the shaft is linearly movable between a first position and a second position. For example, the shaft could allow the prong on the first locking plate to move into registry with the slot on the second locking plate in the first position, but moves the prong on the first locking plate out of registry with the slot on the second locking plate in the second position. The biasing member may urge the shaft toward the first position. The rotation of the cam overcomes the urging of the biasing member to move the shaft from the first position to the second position, thereby moving the prong on the first locking plate out of registry with the slot on the second locking plate.

Another embodiment of the present invention includes a hitch assembly with a hitch portion having an opening configured to receive a hitch-mounted accessory in which the hitch portion is rotatable between an extended position and a retracted position. The hitch assembly may include a lock configured to selectively fix the hitch portion in either the extended position or the retracted position. In some cases, the lock includes a first locking plate that is rotatable with respect to a second locking plate. The first locking plate may include at least one prong that is configured to be received in at least one slot defined in the second locking plate. The first locking plate may be movable between a locked position in which the prong is received by the slot to limit rotation of the first locking plate with respect to the second locking plate and an unlocked position in which the prong is out of the slot so the first locking plate can rotate freely with respect to the first locking plate. The hitch assembly may include a release assembly configured to move the first locking plate between the locked position and the unlocked position. The release assembly includes a shaft that is linearly movable between a first position and a second position. The release assembly may include a biasing member that urges the shaft toward the first position. The shaft may include an end adapted to move the first locking plate to the unlocked position when the shaft moves from the first position to the second position. The release assembly may include an elongated input member with an edge that acts as a cam to move the shaft from the first position to the second position when the input member is rotated.

A further embodiment of the present invention includes a method of rotating a hitch assembly between an extended position and a retracted position. The method may include the step of providing a hitch portion capable of rotating between an extended position and a retracted position in which a lock is adapted to selectively fix the hitch portion in either the extended position or the retracted position. The lock may be unlocked so that the hitch portion is freely movable between the extended position and the retracted position. The lock may be unlocked by rotating a cam in a first cam direction to actuate linear movement of a shaft in a first shaft direction. The cam could rotate about a pin disposed in a longitudinally extending slot in the shaft. Next, the hitch portion could be rotated to either the extended position or the retracted position. The hitch portion could be locked to fix it in either the extended position or the retracted position. The lock may be locked by a biasing member urging linear movement of the shaft in a second shaft direction to rotate the cam in a second cam direction.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a perspective view of an example hitch assembly according to an embodiment of the invention in an extended position;

FIG. 2 is a perspective view of the hitch assembly shown in FIG. 1 in a retracted position;

FIG. 3 is a hitch assembly according to an embodiment of the invention in an extended position;

FIG. 4 is the hitch assembly shown in FIG. 3 in a retracted position;

FIG. 5 is a perspective view of the hitch assembly shown in FIG. 3 without the hitch in a closed position;

FIG. 6 is a side view of the hitch assembly shown in FIG. 5;

FIG. 7 is a cross-sectional view of the hitch assembly shown in FIG. 5 along line 7-7 of FIG. 6;

FIG. 8 is a cross-sectional view of the hitch assembly shown in FIG. 5 along line 8-8 of FIG. 6;

FIG. 9 is a perspective view of the hitch assembly shown in FIG. 5 in an open position;

FIG. 10 is a side view of the hitch assembly shown in FIG. 9;

FIG. 11 is a cross-sectional view of the hitch assembly shown in FIG. 9 along line 11-11 of FIG. 10;

FIG. 12 is a cross-sectional view of the hitch assembly shown in FIG. 9 along line 12-12 of FIG. 10; and

FIG. 13 is a perspective view of a hitch assembly according to an alternative embodiment.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

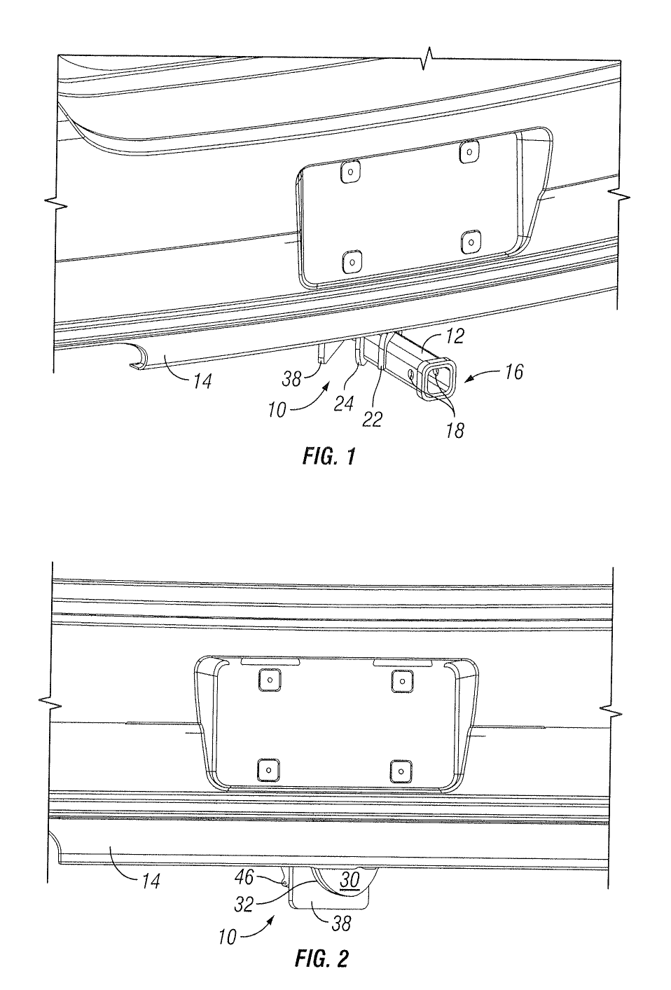

FIGS. 1 and 2 show a hitch assembly 10 according to an embodiment of the invention that pivots between extended and retracted positions. In FIG. 1, the hitch assembly 10 is in the extended position; FIG. 2 shows the hitch assembly 10 in a retracted position. In the extended position, a hitch portion 12 is positioned to receive a trailer, hitch-mounted bike rack, or other hitch-mounted accessories. In the retracted position, the hitch portion 12 is in a relatively hidden position behind the bumper 14.

As shown, the hitch portion 12 includes an opening 16 that is configured to receive the accessory to which the hitch assembly 10 is to be connected. As shown, the hitch portion 12 includes locking holes 18 through which a pin (not shown) may be used to lock the accessory being received. It should be appreciated, however, that the hitch portion 12 could take other shapes and dimensions depending upon the type of accessory to which the hitch assembly 10 is to be connected.

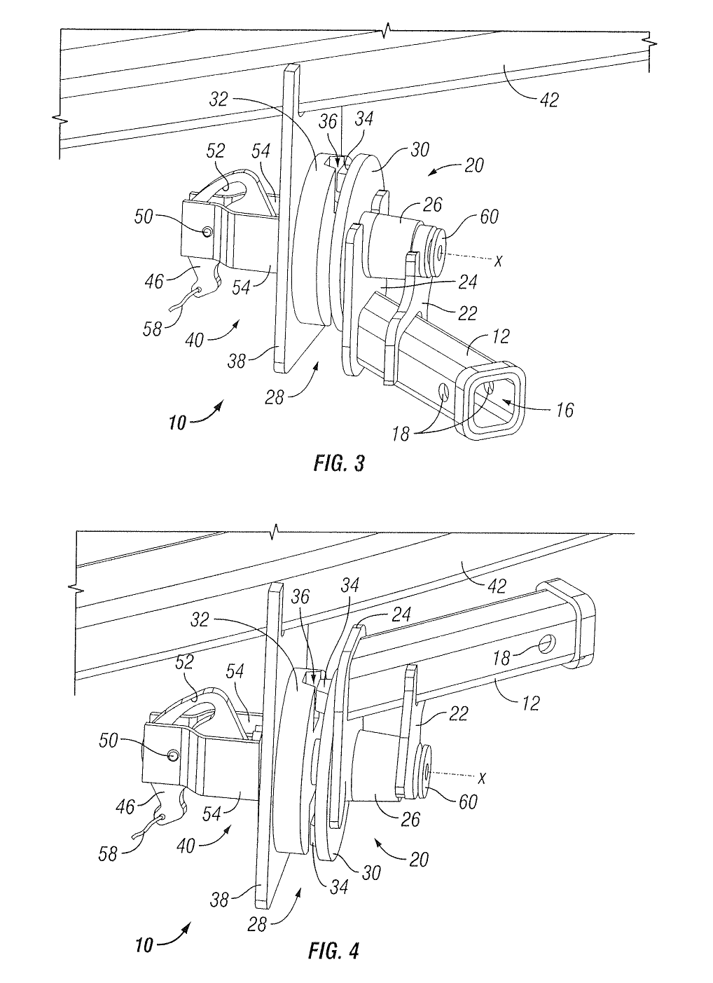

Referring to FIGS. 3 and 4, the hitch assembly 10 is shown in extended and retracted positions, respectively. As shown in this example, the hitch portion 12 is connected to a rotating member 20 via a first support 22 and a second support 24. This allows the hitch portion 12 to rotate substantially co-axially with the rotating member 20 about the X axis. In the example shown, the rotating member 20 includes a collar portion 26 to which the first support member 22 and the second support member 24 are connected.

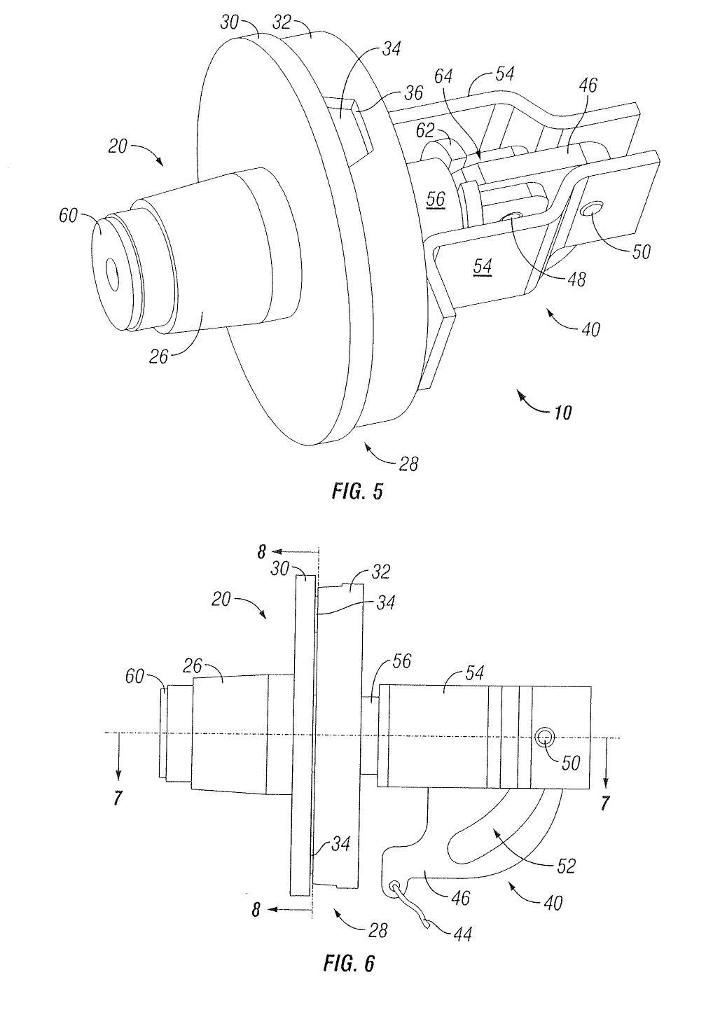

The position of the rotating member 20 may be selectively fixed with a lock 28. This allows the hitch portion 12 to be fixed in either the extended or retracted position as desired. In the example shown, the lock 28 is formed by a first locking plate 30 of the rotating member 20 and a second locking plate 32. As shown, the first locking plate 30 includes prongs 34 that are received in slots 36 formed in the second locking plate 32. As explained in more detail below, the first locking plate 30 is linearly movable so that the prongs 34 may come in and out of registry with the slots 36 and the second locking plate 32. In this embodiment, the first locking plate 30 may be linearly moved along the axis X to unregister the prongs 34 out of the slots 36 so that the first locking plate 30 (and therefore the rotating member 20) may freely rotate about the X axis to move between the extended and retracted positions. When the rotating member 20 may freely rotate about the X axis (because the prongs 34 are not registered in the slots 36), this will be referred to as the “open” or “unlocked” positions which are shown in FIGS. 3 and 4. When the prongs 34 are registered in the slots 36, such that the rotating member 20 is fixed in position, this will be referred to as the “closed” or “locked” position, as shown in FIGS. 5-8.

As shown in this example, a frame 38 is disposed between the second locking plate 32 and a release assembly 40. The frame 38 is connected, in this embodiment, to a portion of the vehicle's chassis 42 so that the hitch assembly 10 is carried or supported by the chassis 42.

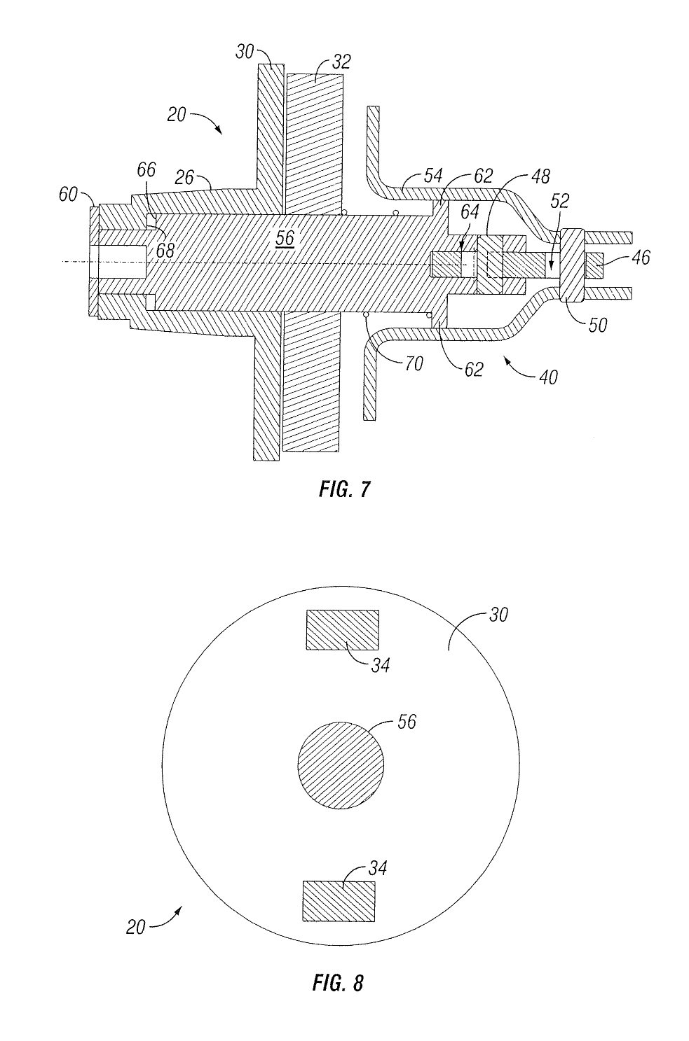

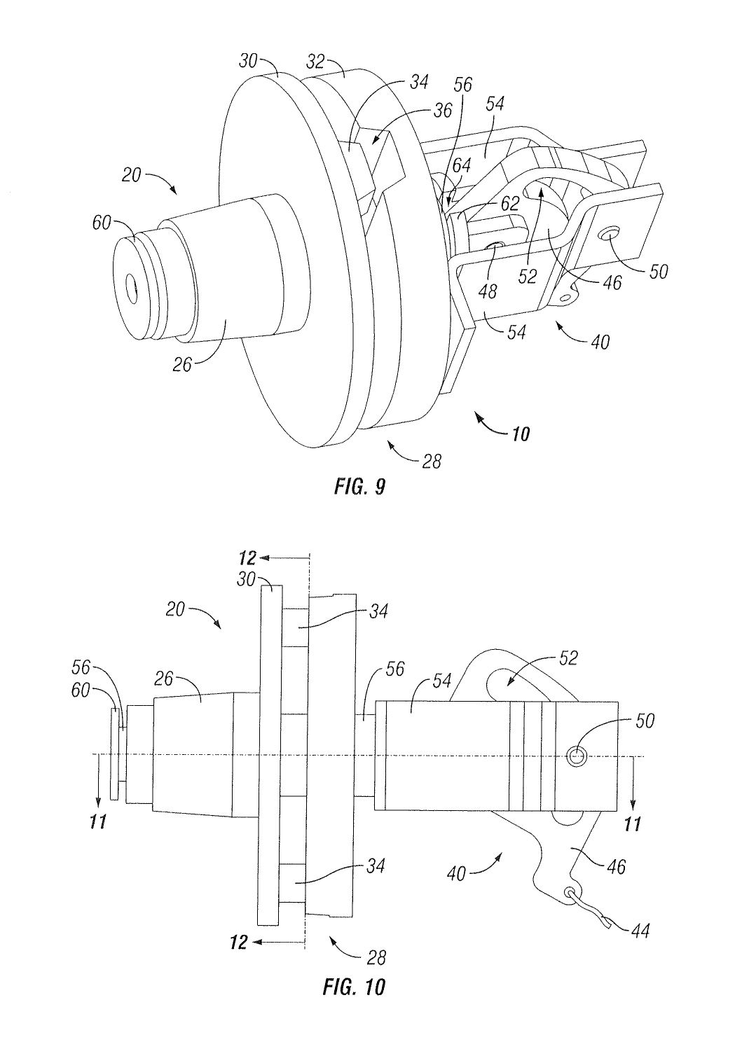

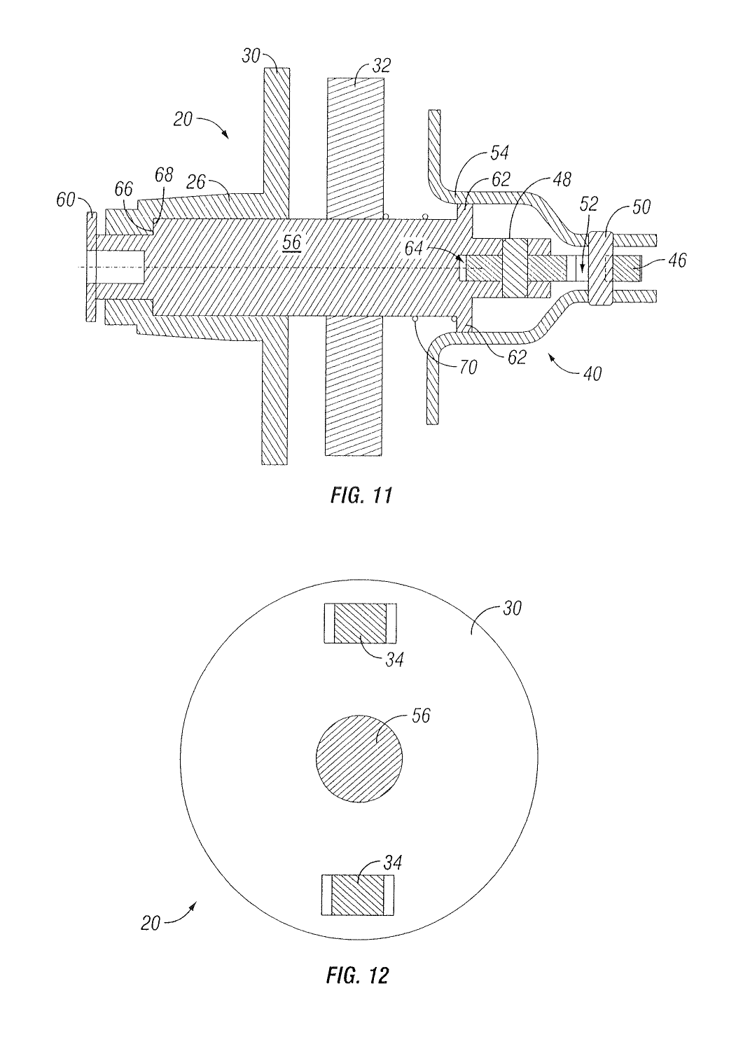

The release assembly 40 moves the rotating member 20 between the locked and unlocked positions. In the example shown, the release assembly 40 causes a longitudinal movement along the X axis of the rotating member 20, which moves the prongs 34 in and out of registry with the slots 36. In some embodiments, for example, the release assembly 40 includes an input member 46 that is movable between an initial and released positions. As shown, the input member 46 rotates about a pivot pin 48 (see FIGS. 5 and 9). A cam pin 50 is received within a cam slot 52 in the embodiment shown to guide the pivoting movement of the input member 46. In this embodiment, the release assembly 40 includes a release assembly frame 54 that prevents lateral movement of the input member 46. As described below, movement of the input member 46 between the initial position and the released position causes a leading edge of the input member to move a shaft 56 (see FIGS. 7 and 11) which in turn locks and unlocks the rotating member. As shown, a cable 58 is attached to the input member 46 so that the user may easily move the input member 46 between the initial and released positions.

FIGS. 5 through 8 show various views of the hitch assembly 10 shown in FIGS. 3 and 4 without the hitch portion 12, supports 22, 24, and frame 38 connected to the chassis 42 for purposes of illustration. In these figures, the lock 28 is in a closed position. In this embodiment, movement of the shaft 56 (best seen in FIG. 7) moves the rotating member 20 between the open and closed positions. As shown, the shaft 56 includes a first end attached to a cap 60 and a second end with a flange 62. The cap 60 acts as a stop to prevent the rotating member 20 from sliding off the shaft 56. In the embodiment shown, the rotating member 20 is, therefore, disposed between the cap 60 and the second locking plate 32 and includes a hole that is dimensioned to receive the shaft 56. The flange 62 is disposed between the release assembly frame 54 to prevent lateral movement of the shaft 56. In the embodiment shown, the shaft 56 includes a slot 64 that is dimensioned to receive the input member 46. The movement of the input member 46 from the initial position to the release position provides a cam action on the shaft 56 to linearly move the shaft 56 along its longitudinal axis.

The shaft includes a leading edge 66 that is configured to engage an internal surface 68 of the rotating member 20 to actuate linear movement of the rotating member 20. This movement allows the prongs 34 in the first locking plate 30 to unregister from the slots 36 in the second locking plate 32 so that the rotating member 20 may freely rotate about the shaft 56.

FIGS. 9 through 12 show various views of the hitch assembly 10 corresponding to the views in FIGS. 5-8 in the open position. As best seen in FIG. 11, the movement of the shaft 56 has caused the leading edge 66 to engage the internal surface 68, thereby moving the first locking plate 30 so that the prongs 34 are not in registry with the slots 36. Accordingly, a user wishing to move the hitch assembly 30 between the extended and retracted positions, can actuate the input member 46, which causes movement of the shaft 56, thereby unlocking the lock 28 so that the hitch portion 12 can be moved to the desired position.

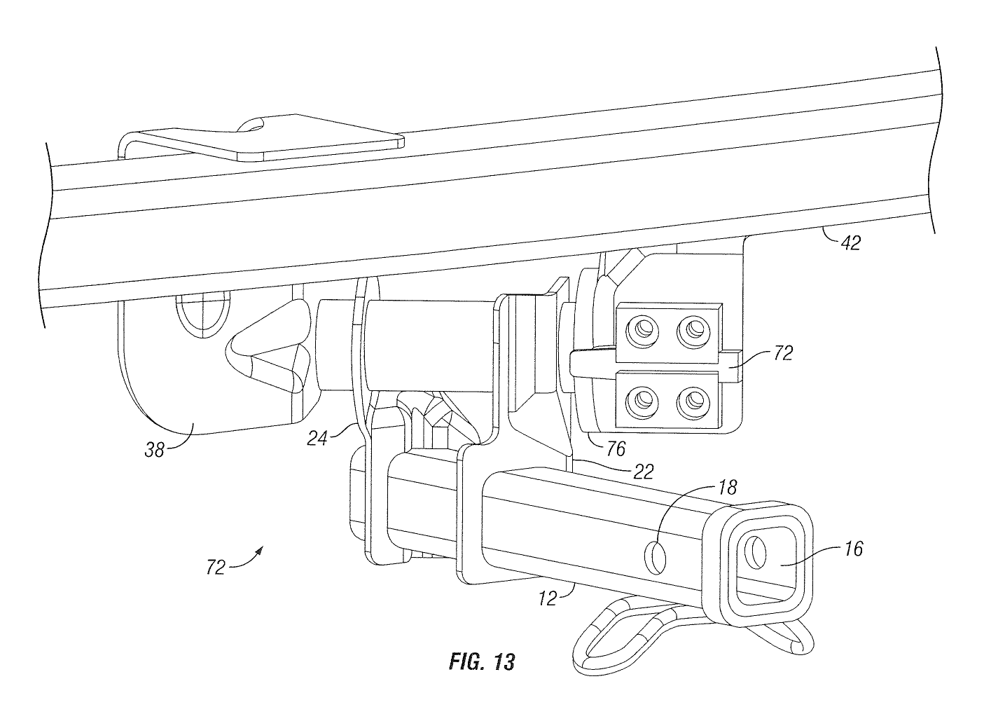

FIG. 13 shows a hitch assembly 72 according to an alternative embodiment. In this embodiment, the hitch portion 12. In this embodiment, a locking pin 74 is provided to selectively fix the position of a rotating member 76.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A hitch assembly comprising:
a hitch portion including an opening for receiving a hitch-mounted accessory, wherein the hitch position is rotatable between an extended position and a retracted position;
a lock including a first locking plate with at least one prong and a second locking plate with at least one slot configured to receive the prong on the first locking plate, wherein the lock is configured to selectively fix the hitch portion in either the extended position or the retracted position when the prong is received in the slot;
a release assembly including a shaft, a rotatable cam that acts on a surface of the shaft, and a biasing member;
wherein the shaft is linearly movable between a first position and a second position, wherein the shaft allows the prong on the first locking plate to move into registry with the slot on the second locking plate in the first position, but moves the prong on the first locking plate out of registry with the slot on the second locking plate in the second position;
wherein the biasing member urges the shaft toward the first position; and
wherein rotation of the cam overcomes the urging of the biasing member to move the shaft from the first position to the second position, thereby moving the prong on the first locking plate out of registry with the slot on the second locking plate.

2. The hitch assembly of claim 1, wherein the shaft includes a first end that contacts the first locking plate when the shaft moves to the second position and a second end with a surface that is actuated by the cam.

3. The hitch assembly of claim 2, wherein the second end of the shaft includes a longitudinally extending slot, wherein the slot receives at least a portion of the cam.

4. The hitch assembly of claim 3, further comprising a pin extending laterally in the slot, wherein the cam pivots about the pin.

5. The hitch assembly of claim 1, wherein the shaft extends through at least a portion of the lock.

6. The hitch assembly of claim 5, wherein the shaft extends through the first locking plate.

7. The hitch assembly of claim 5, wherein the shaft extends through the second locking plate.

8. The hitch assembly of claim 1, wherein the cam rotates about an axis that is approximately perpendicular with a longitudinal axis of the shaft.

9. The hitch assembly of claim 1, wherein the release assembly includes a frame with a first frame member spaced apart from a second frame member and the shaft includes an outwardly extending flange that rides on the first member and the second member to reduce lateral movement of the shaft.

10. A hitch assembly comprising:
a hitch portion with an opening configured to receive a hitch-mounted accessory, wherein the hitch portion is rotatable between an extended position and a retracted position;
a lock configured to selectively fix the hitch portion in either the extended position or the retracted position, wherein the lock includes a first locking plate that is rotatable with respect to a second locking plate, wherein the first locking plate includes at least one prong that is configured to be received in at least one slot defined in the second locking plate, wherein the first locking plate is movable between a locked position in which the prong is received by the slot to limit rotation of the first locking plate with respect to the second locking plate and an unlocked position in which the prong is out of the slot so the first locking plate can rotate freely with respect to the first locking plate; and
a release assembly configured to move the first locking plate between the locked position and the unlocked position, wherein the release assembly includes a shaft that is linearly movable between a first position and a second position, wherein the release assembly includes a biasing member that urges the shaft toward the first position, wherein the shaft has an end adapted to move the first locking plate to the unlocked position when the shaft moves from the first position to the second position, wherein the release assembly includes an elongated input member with an edge that acts as a cam to move the shaft from the first position to the second position when the input member is rotated.

11. The hitch assembly of claim 10, wherein the release assembly includes a frame with a first frame member spaced apart from a second frame member, wherein the input member is disposed between the first member and the second member.

12. The hitch assembly of claim 11, wherein the release assembly includes a pin extending between the first member, wherein the input member includes an arcuate slot that is received by the pin.

13. The hitch assembly of claim 12, wherein the arcuate slot is shaped to guide rotation of the input member.

14. The hitch assembly of claim 13, wherein the shaft includes a first end that contacts the first locking plate when the shaft moves to the second position and a second end with a surface that is actuated by the edge of the input member.

15. The hitch assembly of claim 14, wherein the second end of the shaft includes an outwardly extending flange that is rides between the first member and the second member to reduce lateral movement of the shaft.

16. The hitch assembly of claim 14, wherein the second end of the shaft includes a longitudinally extending slot, wherein the slot receives at least a portion of the input member.

17. The hitch assembly of claim 16, further comprising a pin extending laterally in the slot, wherein the input member pivots about the pin.

18. The hitch assembly of claim 17, wherein the edge of the input member acts on a surface of the shaft in the longitudinally extending slot to move the shaft from the first position to the second position.

19. The hitch assembly of claim 10, wherein the input member is substantially planar in shape.

20. The hitch assembly of claim 10, wherein the shaft extends through at least a portion of the lock.

21. A method of rotating a hitch assembly between an extended position and a retracted position, the method comprising the steps of:
providing a hitch portion capable of rotating between an extended position and a retracted position, wherein a lock is adapted to selectively fix the hitch portion in either the extended position or the retracted position;
unlocking the lock so that the hitch portion is freely movable between the extended position and the retracted position, wherein the lock is unlocked by rotating a cam in a first cam direction to actuate linear movement of a shaft in a first shaft direction, wherein the cam rotates about a pin disposed in a longitudinally extending slot in the shaft;
rotating the hitch portion to either the extended position or the retracted position; and
locking the lock so the hitch portion is fixed in either the extended position or the retracted position, wherein the lock is locked by a biasing member urging linear movement of the shaft in a second shaft direction to rotate the cam in a second cam direction.
